(19) United States
(12) Patent Application Publication
(10) Pub. No.: US 2016/0314279 A1
(43) Pub. Date: Oct. 27, 2016

(54) SYSTEMS, METHODS AND DEVICES FOR ENSURING QUALITY IN HEALTHCARE AND WELLNESS

(71) Applicant: The Arizona Board of Regents on Behalf of the University of Arizona, Tucson, AZ (US)

(72) Inventors: Marvin SLEPIAN, Tucson, AZ (US); Stephanie ZAWADA, Tucson, AZ (US)

(21) Appl. No.: 15/136,869

(22) Filed: Apr. 22, 2016

Related U.S. Application Data
(60) Provisional application No. 62/151,294, filed on Apr. 22, 2015.

(51) Int. Cl. G06F 19/00; G06F 3/0484; G06F 3/0481; G06T 13/40

(52) U.S. Cl. CPC G06F 19/3487; G06F 19/345; G06T 13/40; G06F 3/0484; G06F 3/0481

(57) ABSTRACT

Systems and methods for tracking health and providing feedback are disclosed. The invention provides novel systems and methods for receiving the input of a plurality of health variables associated with a patient, processing those health variables to calculate composite wellness, performance, and disease/decay variables. The systems and methods convert the wellness, performance, and disease/decay variables into graphical representations that are displayed against a time axis. The graphical representations update in real-time based on the input of additional health variable data. The systems and methods are also capable of outputting alarms based on tracked data, providing recommendation for improving the wellness, performance, and disease/decay variables in the future. The systems and methods use sensors and user-inputs to provide such functionalities.

### FIELD OF THE INVENTION

The present invention relates to systems, methods and devices that utilize data associated with an individual or subject's health to track their health and provide feedback.

### BACKGROUND OF THE INVENTION

The understanding, acceptance and overall “handling,” i.e. psychological and physiological (practical) management, of illness and overall health conditions is often incomplete and poorly handled by an individual. Similarly, associated family and friends, while often having good intentions and a desire to help, often have even less connection to the health processes—i.e. illness, wellness routine or other health-related state, that the subject individual is in the grips of. The consequences of poor handling of the health condition are persistence or recurrence of illness, reduction of wellness and possible hospital readmission or further morbidity and even mortality.

Systems exist to analyze and manage complex processes such as project management techniques including Gantt charts, PERT charts and critical path analysis. These however are typically aimed at managing artificially constructed projects and not directed to physiologic processes or disease processes. Further these are aimed at management of individuals and finance and not the multiplicity of elements involved in physiologic processes. A myriad of web-based, computer-based and other digital media systems also exist, e.g. WebMD or MediVizor, to provide information about diseases; however they are without the active interventional or therapeutic potential as is delineated in the present invention.

### SUMMARY OF THE INVENTION

The present invention describes a system which develops and defines an operational pathway with specified elements, for the illness or health condition of a given individual, based on input data and monitored variables, i.e. it deconstructs these processes into defined elements or components. The pathway and elements of the system include those related to: 1. understanding of the health condition; 2. steps to be taken at any moment of time along the progression of the pathway to affect the pathway outcome—including medications, nutrition, physical activities, rest, sleep and rehabilitation aspects, health care system encounters, behaviors and suggested modifications, target outcomes, return to work status, and the like; 3. questions to ask at any moment of time along the progression of the pathway; and 4. similar variables that impact on pathway progression and outcomes.

The pathway is continuously, instantly available for display and interrogation on electronic media devices for the individual (patient) as well as those permissioned to view. The system and pathway is self-correcting/adjusting as new input data is entered. The system has suggested prompts, questions and actions for any moment of time along the progression of the pathway—which are interrogatable or actively displayed and “alarmed,” if suggested pathway actions or events begin deviating. Prompts, questions and actions may actively be telemetered or otherwise automatically transmitted to appropriate action sites to insure an appropriate action or step is taken. The overall system may function as a closed loop with continuous input and feedback provided by data entered manually or via automatic means from input sensors. The system also may be adjusted to match and best interact with a given individual based upon an initial evaluation of understanding, level of engagement, support circumstances and attitudinal and behavioral issues.

### BRIEF DESCRIPTION OF THE FIGURES

A more complete appreciation of the invention and many of the attendant advantages thereof will be readily obtained as the same becomes better understood by reference to the following detailed description when considered in connection with the accompanying drawings, wherein:

FIG. 1 shows a hardware implementation of the invention, in accordance with an exemplary embodiment of the invention;

FIG. 2 shows a software application and its graphical user interface, in accordance with an exemplary embodiment of the invention;

FIG. 3 shows an exemplary software pathway, in accordance with an exemplary embodiment of the invention;

FIG. 4 shows an exemplary software pathway used by the system to determine the level of understanding of the patient;

FIG. 5 shows an exemplary method by which the system issues notices, recommendations, and/or alerts; and

FIG. 6 shows an exemplary embodiment of the buddy avatar that may appear as part of the application graphical user interface.

### DETAILED DESCRIPTION OF THE INVENTION

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose. Several preferred embodiments of the invention are described for illustrative purposes, it being understood that the invention may be embodied in other forms not specifically shown in the drawings.

The present invention is comprised of systems and methods including an analytical logic flow, developed as a “smart, continuously enhancing” algorithm engine (machine learning/artificial intelligence-like) which defines and yields events, states, status or milestones—derived from entered data or continuously uploading data with circumstance and content correction, that accurately describes and reflects the natural history of a given “wellness” or illness. Associated with each identified event, state, status or milestone are “pop up” questions; reminders; actions—suggested or effectuated, induced, or actual; and alarms which by their nature are placed to have an impact on steering and evolving the subsequent path or natural history of the wellness or illness.

All of these components—i.e. the natural history path with its component elements and the pop up interventional signposts and alarms—are developed and fashioned as a digital electronic system that may be displayed on digital devices, including but not limited to computers, handheld devices, smartphones, displays, projections, virtual reality systems and the like. The display and graphics of the system may be 2-dimensional or as a 3-dimensional representation. The progression and milestones may be reproduced as a virtual reality animation. The pop ups and alerts may be reproduced and manifest as, on or within a virtual avatar or “Buddy,” a friendly character designed to prompt, interact and make enjoyable or “gamify,” the process.

The system will have the code and means (software and hardware) to store, telemeter or otherwise digitally communicate status, alerts or the actuation of a recognized, necessary action or event, aimed at modifying the overall progress and natural history of the wellness or illness to which it is applied. The overall system and component devices are organized as a “functional whole,” to provide a mechanism to modify and guide the eventual outcome of a specific wellness or illness. The pop up questions, alerts reminders and actions are “tuneable,” to match the level of education, sophistication and behavioral engagement of the subject or patient, so as to personalize the system to further ensure utilization, compliance and enjoyment of use. The level of the individual or patient will be defined at the outset (and repeated over time as needed) through an incorporated assessment means—e.g. a questionnaire, with specified academic content as well as social/behavioral variables.

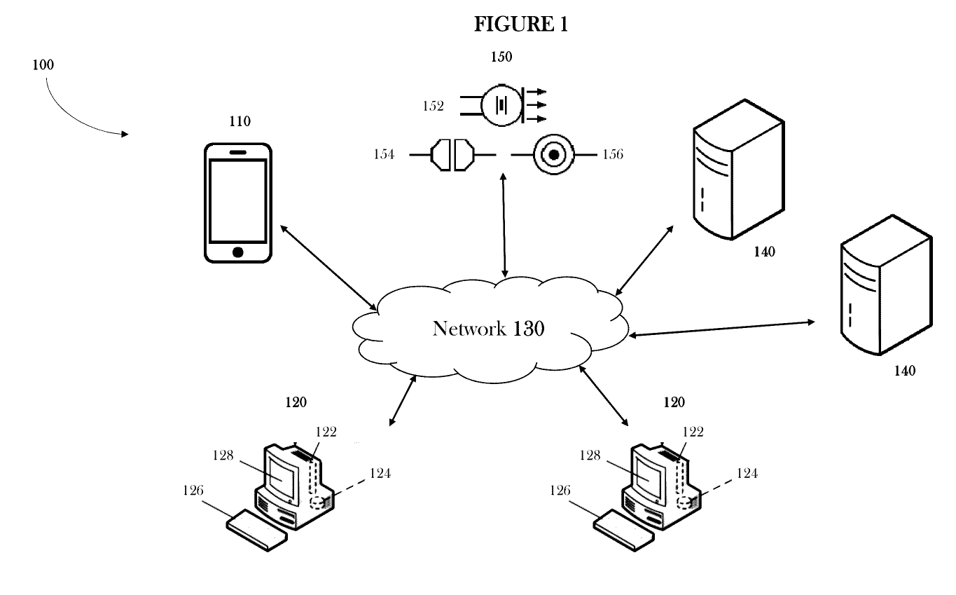

FIG. 1 is an exemplary embodiment of the system. In the exemplary system 100, one or more peripheral devices 110 and/or one or more computers 120 are connected through a network 130 to one or more remote servers 140. The network 130 may be a wide-area network, like the Internet, or a local area network, like an intranet. Because of the network 130, the peripheral devices 110 and the computers 120 have no effect on the functionality of the hardware and software of the invention. Both implementations are described herein, and unless specified, it is contemplated that the peripheral devices 110 and the computers 120 may be in the same or in different physical locations. Communication between the hardware of the system may be accomplished in numerous known ways, for example using network connectivity components such as a modem or Ethernet adapter. The peripheral devices 110 and the computers 120 will both include or be attached to communication equipment. Communications are contemplated as occurring through industry-standard protocols such as HTTP.

Examples of peripheral devices 110 include smartphones, tablets, smartwatches, or any other commercially available networked peripheral devices known in the art. Each computer 120 is comprised of a central processing unit 122, a storage medium 124, a user-input device 126, and a display 128. Examples of computers that may be used are: commercially available personal computers, open source computing devices (e.g. Raspberry Pi), and commercially available servers. In one embodiment, each of the peripheral devices 110 and each of the computers 120 of the system have software related to the visualization system installed on it. In such an embodiment, system data is stored locally on the networked computers 120 or alternately, on one or more remote servers 140 that are accessible to any of the networked computers 120 through a network 130. Data related to the patient's health may be collected through the use of one or more sensors 150 that are in communication with the peripheral devices 110, the computers 120, and the one or more remote servers 140 through the network 130. Any commercially known sensors 150 may be incorporated into the system 100, exemplarily, piezoelectric sensors 152 and electrostatic sensors 154, 156 that are designed to be used for medical purposes. Sensors 150 can include sensors for motion—with six degrees of freedom as to direction, acceleration, angulation and rotation; cardiovascular parameters—e.g. heart rate, blood pressure, ECG, rhythms; pH; O2, CO2 and other gases; electrolytes; hemoglobin; material properties—i.e. stiffness; hydration; sweat and the like.

On one or more of the peripheral devices 110 or computers 120, the system is configured to install an application 200 that performs user-facing activities. The application 200 is preferably comprised of a graphical user interface (“GUI”) 210. The GUI 210 is further comprised of selectable sections including Quizzes 211, Question Generation 212, Education 213, Notes 214, and My Profile 215. By selecting Quizzes 211, a patient is taken by the application 200 to quizzes that are used to determine the patient's psychological profile. The results of these quizzes are used to tailor the application's future interactions with the patient to his or her psychological characteristics. Exemplarily, the psychological profile may be determined using questions that relate to the “big five” personality traits: openness to experience, conscientiousness, extraversion, agreeableness, and neuroticism. Quizzes 211 may also be used to query the patient for inputs related to the medical condition(s) being monitored by the application 200. While this data is also collected by sensors 150 in communication with the application 200, the patient may also manually enter data to the application 200 using the Quizzes 211 section.

By selecting Question Generation 212, the application 200 takes the patient to a section that queries the patient for specific health-related information, based on the data received by the application 200 from the sensors 150 and the Quizzes 211. The questions asked exemplarily query the patient about his physical activity, diet, or sleep patterns, and whether any variations in health-related characteristics have deviated from the expected range. Question Generation 212 may also automatically generate and store questions for the patient's medical practitioner, based on the results of the patient's quiz results. By selecting Education 213, the patient is directed to a section that provides the patient with information related to the medical condition(s) being monitored, treatments, and other information that is relevant to the patient's current state. For example, if the patient is at risk of certain complications due to his biometric statistics, then the section will highlight information about those risks and advise the patient on how those complications can be minimized. Through Education 213, the patient may also receive medical practitioner-curated news and articles relevant to the patient's medical condition(s). Those news and articles may be transmitted to the application 200 through the network 130 or loaded through a physical connection (i.e. USB) during a visit to the medical practitioner. By selecting Notes 214, the patient is directed by the application 200 to section in which the patient can type in comments and notes that may be transmitted to his medical practitioner via the network 130, or stored locally to be shared during the patient's scheduled visits to the medical practitioner. By selecting My Profile 215, the patient is directed by the application 200 to a section that allows the patient to enter personal characteristics such as race, gender, age, weight, and height. These characteristics may be used by the application 200 to tailor the other sections to best suit the patient's profile.

Individual Status/Engagement and Assessment System

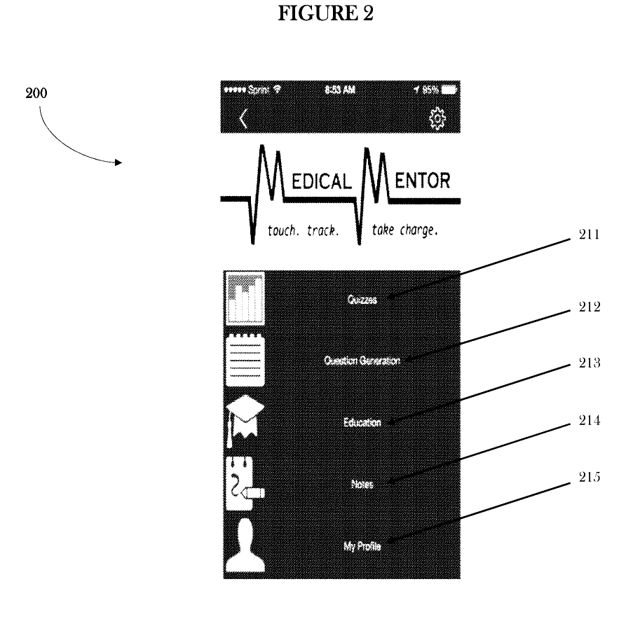

As explained with respect to FIG. 2, to engage with the system the individual has the opportunity and/or requirement to first undergo an engagement process to otherwise tune and optimize the overall system to them. This engagement process effectively is an evaluation mechanism or simple test determining a range of variables which are important to otherwise match and sink the system to their level of comprehension in psychological engagement, thereby optimizing the performance of the system and enhancing the efficacy a possible outcomes. As such, this initial about a mechanism can have a number of variables or test elements. Typically it will have an element related to educational status and understanding of basic physiology, overall health and nutrition and understanding of disease. Additionally it typically will have psychological test element determining the range of attitude and behavior as to an active or even an overactive desire to improve health, to a positive engagement in generally positive attitude, to a neutral attitude, to frank disregard, denial, disgust or even resistance.

Additional test variables may include stress level, financial status, family and social concerns, drug use, aversion to medication, interest and activity, physical and otherwise. The overall goal is to create a picture, quotient and level for the individual which the overall system will then recognize and adjust to. The adjustment will be primarily as it relates to the pop-ups, the questions, the information and the activities and other interventions. To provide a practical example we can take the case of a patient with congestive heart failure. If it is deemed that he or she has a high level of academic understanding of the biology and pathophysiology of their disease, is actively engaged in therapeutics and an overall positive attitude and behavior, then a typical pop-up for this patient upon discharge would be aspects related to pathophysiology of disease, i.e. answers to questions that they may pose, specific details about the medications—beyond the dosing frequency details as the mechanism of action, suggested physical activities, details about diet.

On the other hand if initial evaluation reveals that the patient has minimal understanding of their disease, minimal educational level, and frankly is recalcitrant or resistant to therapy, then the pop-ups would be tailored to providing basic information as to their disease without excessive burden as to detailed pathophysiology. Similarly as to medications, the most basic elements would be provided as to dose and frequency and perhaps a word about what it does, i.e. lowers blood pressure, makes the heart pump better, without all the detail otherwise provided. The system would have the ability that if the patient desires to go deeper this may be accessed, as it is all contained within the system anyway. On the other hand on the initial displayed or portrayed level these elements would be avoided to “de-clutter,” and otherwise prevent “turning off,” the patient with excessive detail.

It is to be understood that for all these elements a spectrum that is fairly continuous exists. However, in specific configurations of the invention, these elements will be partitioned into typically three or four levels to allow easy operability of the system. These elements whether one or multiple will be arranged into a sequenced questionnaire. Typically this will be done in a fun unoppressive fashion with simple questions with a fun positive visual display with pictorial or other elements keeping patients attention. The elements will then be meshed to create a score, quotient or overall level for the individual patient.

### Example 1

### Medical Mentor Intro Survey Design

Twenty (20) questions were asked in the introductory quiz to assess the initial level of patient engagement. Three (3) categories of questions (based upon three levels of Bloom's Taxonomy) were incorporated into the quiz, reflecting the learning readiness of survey participants: 1) knowledge, 2) application, and 3) synthesis.

| Question # | Level | (%) |
|---|---|---|
| 1 | Knowledge | 2.0 |
| 2 | Synthesis | 10.0 |
| 3 | Application | 4.5 |
| 4 | Knowledge | 2.0 |
| 5 | Synthesis | 10.0 |
| 6 | Application | 4.5 |
| 7 | Synthesis | 10.0 |
| 8 | Application | 4.5 |
| 9 | Application | 4.5 |
| 10 | Application | 4.5 |
| 11 | Application | 4.5 |
| 12 | Knowledge | 2.0 |
| 13 | Knowledge | 2.0 |
| 14 | Knowledge | 2.0 |
| 15 | Knowledge | 2.0 |
| 16 | Application | 4.5 |
| 17 | Application | 4.5 |
| 18 | Knowledge | 2.0 |
| 19 | Synthesis | 10.0 |
| 20 | Synthesis | 10.0 |

Knowledge-based questions inquired about a participant's recall of and comfort with health-related facts. The app is then tailored to direct patient progress via presenting and demonstrating information. These questions were assigned a maximum weight of 2.0%. The quiz included seven (7) knowledge-based questions. The numerical answer for each question was associated with a specific weight corresponding to the nature of the question as shown below:

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

Application-based questions inquired about a participant's ability to apply factual information to individual health-related events and to form new, personal conclusions. The app is then tailored to direct patient progress via facilitating patient learning and encouraging active health-related practices. These questions were assigned a maximum weight of 4.5%. The quiz included eight (8) application-based questions. The numerical answer for each question was associated with a specific weight corresponding to the nature of the question as shown below:

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

Synthesis-based questions inquired about a participant's ability to problem-solve independently, curate reliable information, and self-manage procedures in health-related situations. The app is then tailored to direct patient progress via providing more in-depth health-related information and treatment option data. These questions were assigned a maximum weight of 10%. The quiz included five (5) synthesis-based questions. The numerical answer for each question was associated with a specific weight corresponding to the nature of the question as shown below:

### Learning Readiness=Synthesis

| Numerical Answer for Question | Calculated Weight (% Total) |
|---|---|
| 1 | 2.0 |
| 2 | 4.0 |
| 3 | 6.0 |
| 4 | 8.0 |
| 5 | 10.0 |

### Example 1

### Medical Mentor Intro Survey (Continued), with Specific Questions

1. How knowledgeable are you about your current diagnosis? [Scale of 1 (least knowledgeable)-5 (most knowledgeable)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

2. Do you feel overwhelmed when your doctor presents you with information about your health, diagnoses, medications, and/or treatment options? [Scale of 1 (least overwhelmed)-5 (most overwhelmed)]

### Learning Readiness=Synthesis

| Numerical Answer for Question | Calculated Weight (% Total) |
|---|---|
| 1 | 10.0 |
| 2 | 8.0 |
| 3 | 6.0 |
| 4 | 4.0 |
| 5 | 2.0 |

3. How confident do you feel about having a discussion with your doctor about your health, diagnoses, medications, and/or treatment options? (Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

4. Do you feel comfortable sharing questions or concerns with your doctor even if he or she does not ask if you have any? [Scale of 1 (least comfortable)-5 (most comfortable)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

5. Do you feel overwhelmed when researching health and/or diagnoses on your own? [Scale of 1 (least overwhelmed)-5 (most overwhelmed)]

### Learning Readiness=Synthesis

| Numerical Answer for Question | Calculated Weight (% Total) |
|---|---|
| 1 | 10.0 |
| 2 | 8.0 |
| 3 | 6.0 |
| 4 | 4.0 |
| 5 | 2.0 |

6. How confident do you feel about researching health and/or diagnoses on your own? [Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

7. Do you feel overwhelmed when researching medications and/or treatment options on your own? [Scale of 1 (least overwhelmed)-5 (most overwhelmed)]

### Learning Readiness=Synthesis

| Numerical Answer for Question | Calculated Weight (% Total) |
|---|---|
| 1 | 10.0 |
| 2 | 8.0 |
| 3 | 6.0 |
| 4 | 4.0 |
| 5 | 2.0 |

8. How confident do you feel about researching medications and/or treatment options your own? [Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

9. How confident are you in assessing the effectiveness of your medications? [Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

10. How confident are you in assessing the effectiveness of your chosen treatment options? [Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

11. How confident do you feel that you can manage your health condition on your own? [Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

12. How confident are you that you can properly follow through with a prescribed course of treatment? [Scale of 1 (least confident)-5 (most confident)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

13. How confident are you in your knowledge of your health problems and what causes them? [Scale of 1 (least confident)-5 (most confident)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

14. How aware are you of different treatment options available for your condition? [Scale of 1 (least aware)-5 (most aware)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

15. How comfortable are you in determining whether or not a health problem requires you to go to a doctor or if it is something you can resolve yourself? [Scale of 1 (least comfortable)-5 (most comfortable)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

16. How responsible do you feel for your own health? [Scale of 1 (least responsible)-5 (most responsible)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

17. How strongly do you believe you live a healthy lifestyle? [Scale of 1 (strongly disagree)-5 (strongly agree)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

18. How strongly do you feel that you have support from friends and family? [Scale of 1 (strongly disagree)-5 (strongly agree)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

19. How confident are you in your ability to adjust your lifestyle to improve your health? [Scale of 1 (least confident)-5 (most confident)]

### Learning Readiness=Synthesis

| Numerical Answer for Question | Calculated Weight (% Total) |
|---|---|
| 1 | 2.0 |
| 2 | 4.0 |
| 3 | 6.0 |
| 4 | 8.0 |
| 5 | 10.0 |

20. Do you want more options to control and/or understand your health? [Scale of 1 (strongly disagree)-5 (strongly agree)]

### Learning Readiness=Synthesis

| Numerical Answer for Question | Calculated Weight (% Total) |
|---|---|
| 1 | 2.0 |
| 2 | 4.0 |
| 3 | 6.0 |
| 4 | 8.0 |
| 5 | 10.0 |

Results

PATIENT LEVEL 1—Beginner (0-25%)—Patient has indicated limited knowledge of their diagnosis and treatment options, and/or may feel overwhelmed by a multitude of treatment options being presented to them by their physician. For Beginner users, the app will encourage the patient to ask basic questions about their diagnosis, the healthcare system, and the process of their treatment in general. It will provide information about their diagnosis in a very easily understandable fashion.

PATIENT LEVEL 2—Developing (25-50%)—Patient has indicated some knowledge of their diagnosis and treatment options, but may still feel slightly overwhelmed by complex medical information and a multitude of treatment options being presented to them by their physician. The app will encourage the patient to ask more detailed questions about their diagnosis, and “gamification” of progress tracking will be used to push the patient's knowledge toward the next level of engagement.

PATIENT LEVEL 3—Intermediate-Advanced (50-75%)—Patient has indicated significant understanding of their diagnosis, medications and treatment options. App will present the user with detailed information about their diagnosis and treatment options, and will push the patient towards active collaboration with their physician as an equal member of their medical care team through continued “gamification” of progress tracking and question generation geared towards furthering their understanding.

PATIENT LEVEL 4—Independent (75-100%)—Patient likely has a thorough understanding of their diagnosis and has knowledge close to or on par with their doctor. They are persistent in learning about treatments options and lifestyle changes. Patient is willing and able to consistently follow their agreed treatment course. For the Independent patient the app will help patients keep track of their vitals and learn advanced information about their diagnosis.

### Example 2

### Prototype Initial Evaluation/“System Matching” Questionnaire

1. How knowledgeable are you about your current diagnosis? [Scale of 1 (least knowledgeable)-5 (most knowledgeable)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

SCORE 5
CURRENT TOTAL SCORE 0
NEW TOTAL SCORE 5

2. Do you feel overwhelmed when your doctor presents you with information about your health, diagnoses, medications, and/or treatment options? [Scale of 1 (least overwhelmed)-5 (most overwhelmed)]

### Learning Readiness=Synthesis

| Numerical Answer for Question | Calculated Weight (% Total) |
|---|---|
| 1 | 10.0 |
| 2 | 8.0 |
| 3 | 6.0 |
| 4 | 4.0 |
| 5 | 2.0 |

SCORE 2
CURRENT TOTAL SCORE 5
NEW TOTAL SCORE 7

3. How confident do you feel about having a discussion with your doctor about your health, diagnoses, medications, and/or treatment options? (Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

SCORE 5
CURRENT TOTAL SCORE 7
NEW TOTAL SCORE 12

4. Do you feel comfortable sharing questions or concerns with your doctor even if he or she does not ask if you have any? [Scale of 1 (least comfortable)-5 (most comfortable)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

SCORE 5
CURRENT TOTAL SCORE 12
NEW TOTAL SCORE 17

5. Do you feel overwhelmed when researching health and/or diagnoses on your own? [Scale of 1 (least overwhelmed)-5 (most overwhelmed)]

### Learning Readiness=Synthesis

| Numerical Answer for Question | Calculated Weight (% Total) |
|---|---|
| 1 | 10.0 |
| 2 | 8.0 |
| 3 | 6.0 |
| 4 | 4.0 |
| 5 | 2.0 |

SCORE 3
CURRENT TOTAL SCORE 17
NEW TOTAL SCORE 20

6. How confident do you feel about researching health and/or diagnoses on your own? [Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

SCORE 4
CURRENT TOTAL SCORE 20
NEW TOTAL SCORE 24

7. Do you feel overwhelmed when researching medications and/or treatment options on your own? [Scale of 1 (least overwhelmed)-5 (most overwhelmed)]

### Learning Readiness=Synthesis

| Numerical Answer for Question | Calculated Weight (% Total) |
|---|---|
| 1 | 10.0 |
| 2 | 8.0 |
| 3 | 6.0 |
| 4 | 4.0 |
| 5 | 2.0 |

SCORE 2
CURRENT TOTAL SCORE 24
NEW TOTAL SCORE 26

8. How confident do you feel about researching medications and/or treatment options on your own? [Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

SCORE 4
CURRENT TOTAL SCORE 26
NEW TOTAL SCORE 30

9. How confident are you in assessing the effectiveness of your medications? [Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

SCORE 5
CURRENT TOTAL SCORE 30
NEW TOTAL SCORE 35

10. How confident are you in assessing the effectiveness of your chosen treatment options? [Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

SCORE 5
CURRENT TOTAL SCORE 35
NEW TOTAL SCORE 40

11. How confident do you feel that you can manage your health condition on your own? [Scale of 1 (least confident)-5 (most confident)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

SCORE 5
CURRENT TOTAL SCORE 40
NEW TOTAL SCORE 45

12. How confident are you that you can properly follow through with a prescribed course of treatment? [Scale of 1 (least confident)-5 (most confident)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

SCORE 5
CURRENT TOTAL SCORE 45
NEW TOTAL SCORE 50

13. How confident are you in your knowledge of your health problems and what causes them? [Scale of 1 (least confident)-5 (most confident)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

SCORE 5
CURRENT TOTAL SCORE 50
NEW TOTAL SCORE 55

14. How aware are you of different treatment options available for your condition? [Scale of 1 (least aware)-5 (most aware)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

SCORE 4
CURRENT TOTAL SCORE 55
NEW TOTAL SCORE 59

15. How comfortable are you in determining whether or not a health problem requires you to go to a doctor or if it is something you can resolve yourself? [Scale of 1 (least comfortable)-5 (most comfortable)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

SCORE 5
CURRENT TOTAL SCORE 59
NEW TOTAL SCORE 64

16. How responsible do you feel for your own health? [Scale of 1 (least responsible)-5 (most responsible)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

SCORE 5
CURRENT TOTAL SCORE 64
NEW TOTAL SCORE 69

17. How strongly do you believe you live a healthy lifestyle? [Scale of 1 (strongly disagree)-5 (strongly agree)]

### Learning Readiness=Application

| Numerical Answer for Question | Calculated Weight (% Total) |
|---|---|
| 1 | 0.9 |
| 2 | 1.8 |
| 3 | 2.7 |
| 4 | 3.6 |
| 5 | 4.5 |

SCORE 5
CURRENT TOTAL SCORE 69
NEW TOTAL SCORE 74

18. How strongly do you feel that you have support from friends and family? [Scale of 1 (strongly disagree)-5 (strongly agree)]

### Learning Readiness=Knowledge

| Numerical Answer for Question | Calculated Weight (% Total) |
|---|---|
| 1 | 0.4 |
| 2 | 0.8 |
| 3 | 1.2 |
| 4 | 1.6 |
| 5 | 2.0 |

SCORE 5
CURRENT TOTAL SCORE 74
NEW TOTAL SCORE 79

19. How confident are you in your ability to adjust your lifestyle to improve your health? [Scale of 1 (least confident)-5 (most confident)]

### Learning Readiness=Synthesis

| Numerical Answer for Question | Calculated Weight (% Total) |
|---|---|
| 1 | 2.0 |
| 2 | 4.0 |
| 3 | 6.0 |
| 4 | 8.0 |
| 5 | 10.0 |

SCORE 5
CURRENT TOTAL SCORE 79
NEW TOTAL SCORE 84

20. Do you want more options to control and/or understand your health? [Scale of 1 (strongly disagree)-5 (strongly agree)]

### Learning Readiness=Synthesis

| Numerical Answer for Question | Calculated Weight (% Total) |
|---|---|
| 1 | 2.0 |
| 2 | 4.0 |
| 3 | 6.0 |
| 4 | 8.0 |
| 5 | 10.0 |

SCORE 5
CURRENT TOTAL SCORE 84
NEW TOTAL SCORE 89
TOTAL SCORE 89

Illness Pathways

To illustrate the illness pathway we will utilize the example of congestive heart failure. A typical illness pathway may be presented on several levels in this invention. An overall natural history from initial diagnosis to long-term possible evolution, up to and including stabilization, resolution, decline or even death may be presented. In addition, a more focused, limited time natural history may be created for an acute exacerbation of the condition, an example being a hospitalization for an episode of heart failure decompensation. These two scenarios will be illustrated below.

For the long-term visualization and natural history depiction of heart failure this may be broken down into milestones, steps or stages using well described definitions. An example here is the American Heart Association Stages of heart failure including: Stage A having the propensity to have heart failure with associated risk factors and/or genetics. Stage B having early pathologic changes in either heart tissue heart arteries or other physical elements yet without clinical manifestations of heart failure. Stage C as the actual clinical presentation of patients with heart failure with manifest symptoms including loss of exercise capacity, dyspnea on exertion, peripheral edema, fatigue breathlessness, paroxysmal nocturnal dyspnea, nocturia, and the like. Stage D involves clinical worsening of all the above symptoms including dyspnea, additional severe limitation of mobility, persistent breathlessness, hypotension and severe fatigue. Each of these stages may be mapped out. They may be visually presented as a map or as a progression of steps with visual boxes, bubbles or other graphics aligned to represent progression over time. A presentation similar to a critical path or a biochemical pathway may be utilized. Another recognized progression scheme may be utilized such as the New York Heart Association Classes of Heart Failure, i.e. Class I-IV.

This natural history path may be presented two dimensionally or three-dimensionally, with the option for visual representation of a deviation from the path being presented in a downward fashion as if falling off the line, the converse being with adherence maintaining on the line or if with frank improvement, moving above the line.

Using the example of an acute decompensation, here the steps may be much more granular and detailed. An initial milestone or graphic box may be initial presenting symptoms and/or signs. An example here being severe reduction in exercise capacity, increasing paroxysmal nocturnal dyspnea with the patient needing to sleep upright in bed, weight gain with water weight, peripheral edema, lab changes with an elevated BUN and creatinine and an elevated BNP. A next milestone box in the natural history may be initial change with initial medications. Here urine output may increase, weight may go down, blood pressure may improve, breathlessness will improve, ability to sleep flat without pillows may improve, and the like. A next milestone or natural history element may be status at the time of discharge here blood pressure has normalized, respiratory rate is normal urine output has increased edema has decreased BUN and creatinine have normalized and BNP is reduced. It is understood that in this invention all of these example variables will have data entered either manually or automatically via engagement with the electronic health record or an equivalent data source. Data may also be streamed in from wearable or implantable sensors as discussed in other parts of this invention. A next and critical milestone will be that of the status of the patient upon initial outpatient hospital visit. Here, symptomatology will be reviewed, blood pressure vital signs and physical exam, lab tests, medication understanding and adherence and compliance, level of activity and nutrition. An example of a compliant patient would be systolic blood pressure is now in the 105 range, pulse is 50 to 60, breathing is much better, leg edema has been reduced, their medications—e.g. lisinopril 2.5 mg is being taken daily, furosemide at 40 mg they are taking daily, supplemental potassium at 20 mEq they are taking daily and carvedilol at 6.25 mg they're taking twice a day. As to exercise the patient has returned to walking and is engaged in rehab.

As will be discussed below but to emphasize the importance in relation to this aspect of the invention, each one of these elements/variables will be contained in pop-ups so that if the patient is not asking these questions, complying with these treatment elements and similarly the physician is not discussing these and addressing medication and rehab, they will automatically pop up to act as a reminder or will actively transmitter telemetry data to ensure that an action is taken.

Wellness Pathways

To provide an example of a wellness pathway we can use the case of maintaining good flexibility and muscular strength. As we age, early in life we have a peak of optimal status and with time there is progressive decline leading to sarcopenea and loss of flexibility. As such the natural history of muscular strength and flexibility may be depicted as the norm levels known with childhood, adolescence, young adulthood, middle-age, and elderly status. Data exists, from multiple sources to populate these natural history stages. Similarly, flexibility and range of motion data exists for every one of these age points. It is understood that if greater granularity is desired or needed in the system of the present invention then this natural history may be presented as a near continuum with every age depicted from birth to death.

As outlined for illness pathways above, data may be inputted manually, initially or progressively with use of the system or automatically from sensors measuring muscle strength and flexibility and the like.

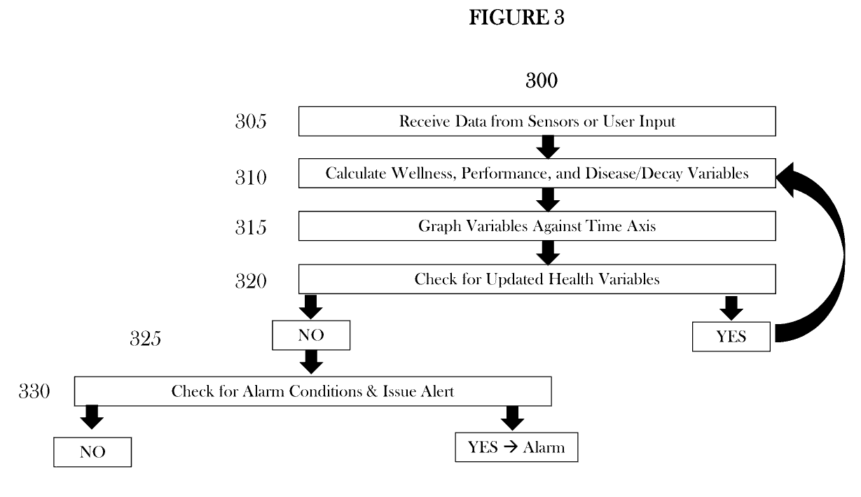

FIG. 3 shows an exemplary software pathway 300 that uses the illness and wellness pathways to track and provide feedback to a patient. At step 305, the application 200, running on a peripheral device 110 or a computer 120 begins by collecting data from the sensors 150 networked to the system 100. The patient may also enter this information, or a medical practitioner may also enter this information through a computer 120 or peripheral device 110 networked to the patient's device through the remote servers 140 and the network 130. The data is stored by the application 200 as health variables. At step 310, the application 200 processes the health variables to calculate composite variables for “wellness,” “performance,” and “disease/decay.” The wellness variable is an approximation of the general health of the patient as compared to a statistical median or mean for a patient with the same or similar medical condition(s). The wellness variable applies data from the wellness pathway disclosed above. The performance variable is an approximation of the patient's progress against the guidelines for health prescribed by his or her medical practitioner and how that patient is performing compared to those goals. The disease/decay variable is an approximation of the patient's rate of progression of the medical condition(s) and whether that condition is advancing or retreating (e.g. white blood cell count as an indicator of infection). The disease/decay variable applies data from the illness pathway disclosed above.

At step 315, the application 200 presents a graphical representation in 2-D or 3-D of the wellness, performance, and disease/decay variables against a time axis against baselines (standard/median/mean). At step 320, the system 100 checks for additional inputs of health variables, either from the patient, the medical practitioner, or the sensors 150. If there has been updated information provided, at step 325, the software returns to step 310, updating the wellness, performance, and disease/decay variables and re-graphing them against baselines.

If no new health variables have been input, then the software proceeds to step 330, and checks interventional steps, milestones, and guideposts, as set by the medical practitioner, the patient, or the system itself, to alert or notice the patient at his or her peripheral device 110 or computer 120 if such a condition has been met. This alert preferably takes the form of an alarm associated with sound or a text notification. The alerts or notices may be advice, actions, question, prescriptions, care plans rehab plans, and the like.

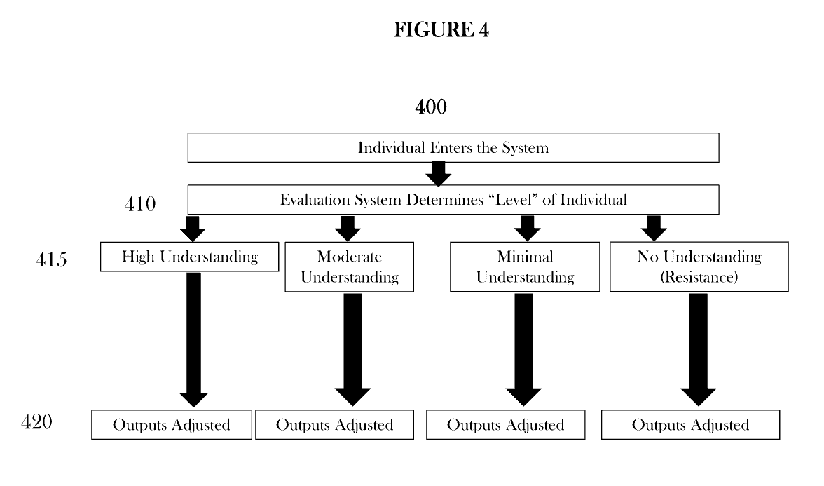

FIG. 4 exemplarily shows a software pathway 400 for how a patient's understanding is used to alter the notices and recommendations provided to the patient. At step 405, the patient accesses the system 100 through the application 200. At step 410, the system 100, as explained above, determines the “level” of understanding of the patient. As shown at step 415, this level of understanding is preferably categorized into “High Understanding,” “Moderate Understanding,” “Minimal Understanding,” and “No Understanding” categories. At step 420, based on the categorization of the patient, the system 100 and/or application 200 tailor notices and recommendations to adjust to the patient's level of understanding.

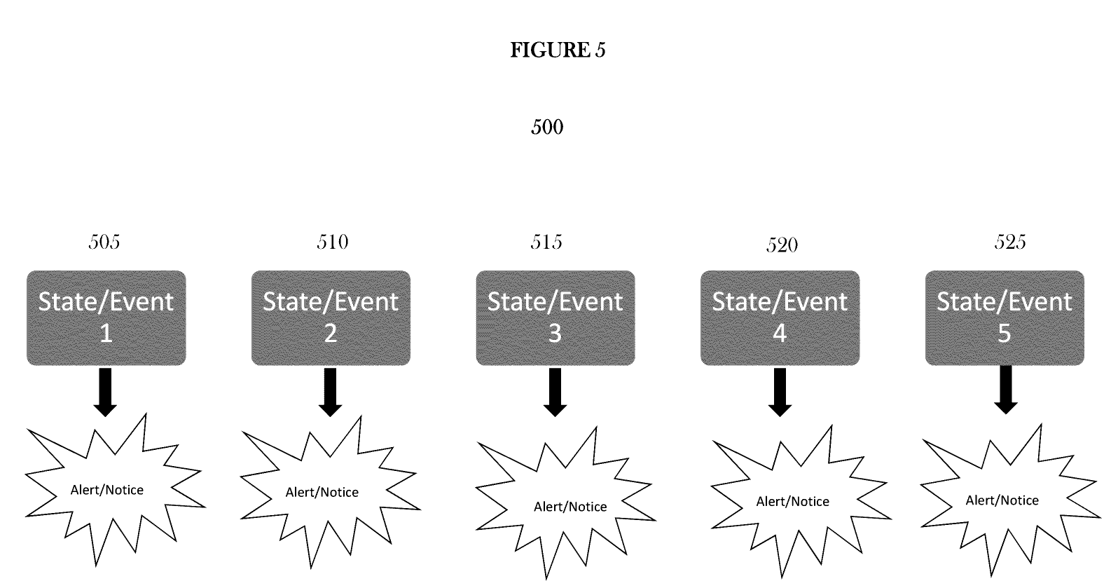

FIG. 5 exemplarily shows how alerts and notices are output by the system 100 and/or application 200. As the patient's health data is input into the system 100, the system 100 tracks the data for one or more states or events. In FIG. 5, the system 100, is tracking the data for one of five states/events, shown as 505, 510, 515, 520, and 525. As the preset criteria for one or more of the states/events 505, 510, 515, 520, and 525 is met, the system 100 and/or application 200 outputs an alert or notice to the patient. This alert or notice is preferably output through the application 200.

System Display Configurations

Two Dimensional:

The system may present milestones with associated interventional pop-ups in a linear or other two-dimensional fashion such as with the viewed on a digital screener device. These include the range of current in future systems such as iPads, cell phone smart phones. These may be moved around and expanded as is currently performed on many tablets.

Three Dimensional:

The system may present milestones and interventional pop-ups in three dimension. This is the preferred embodiment it is envisioned that one may manipulate.

“Buddy Avatar”

A key feature of the present invention is a graphic display element of a “health buddy avatar.” The concept here is that in a graphic display to simplify, guide, make enjoyable and fun a friendly avatar will be depicted. If the system is configured in three dimensions one will be able to see this fun friendly figure acting as a facilitator, ambassador, docent, or guide to facilitate movement through and around the system. This will serve several purposes—it will truly smooth out and facilitate movement through the system, it will make use of the system enjoyable, it will “gamify,” the system and process which ultimately will lead to enhanced use making the overall system and device sensed as being psychologically and otherwise valuable for the participant. One can imagine the health buddy as your friend and assistant, sitting on your shoulder, almost pet like. But even then interacts with you, can visually and verbally talk with you and being a friend that is always having your best interest at heart. This avatar concept is truly the peak and the maximum of what this overall system can do in that it's acting as a Sentinel guide, always on your side, always covering your back to make sure that as you progress through the natural history path you don't miss or mess up a given state or checkpoint.

The buddy may be configured with a generic anthropomorphic type of face, akin to the “Pillsbury dough boy,” or another animated cartoon-like character. Alternatively, for some individuals the buddy may be reconfigured with a known face or a common face. For non-human applications the buddy may be configured with an animal rendition. Even for human applications a favored pet or other creature may be portrayed as the buddy.

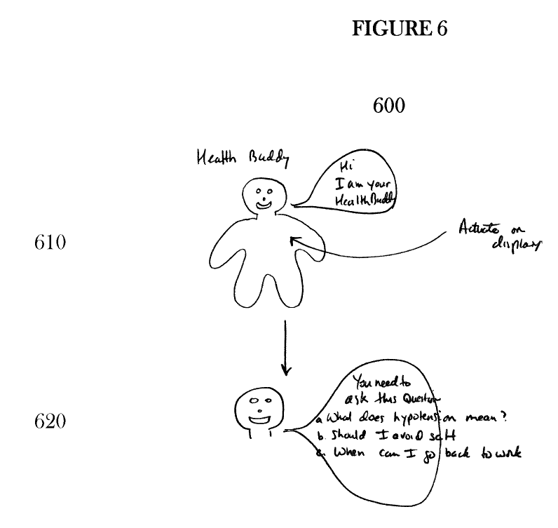

The buddy may be configured, if a 3-D rendition is created on the display, as a virtual avatar, walking with you, alongside, standing in front of you, talking to you, talking up to you or even talking down to you if the system continues to sense and learn that the subject is not actively participating in the program. In other words the buddy can lear both praise and reprimand—as an advanced feature of the system. The “buddy” avatar is exemplarily shown in FIG. 6. The buddy avatar 600 is a dynamic graphical representation. As shown in 610, the buddy avatar can communicate with the patient through the application 200. In certain cases, depending on the inputs received by the system 100 or the application 200, the buddy avatar may, as shown in 620, inform the patient of questions that he or she should ask a medical practitioner on a future visit. The content of those questions will vary based on the health data provided and the level of understanding of the patient.

As explained above, the overall system as well as the buddy may be depicted in two dimensions or three dimensions on digital devices that are either fixed, projected, portable, handheld or wearable. In the future as systems evolve with flexible electronics and wearable displays it is anticipated that the present invention may be integrated and displayed on these systems.

System Operation

As outlined above for the present invention, a natural history path with milestones were stages is created for a given activity or disease state to be tracked. The system will continuously grow and have added specific wellness and illness conditions to follow as the system grows. For each stage in the natural history, as outlined in detail above there may be more or less granularity more depth depending upon the detailed desired. This is independent of the level of engagement of the individual, this refers to the steps in the natural history. As such for each step norms or expected states are entered either manually or automatically. With continued use greater detail, increased accuracy for more information may become available which will allow that state for step to be fine-tuned and otherwise improved. This system will incorporate that feature which will either be manual or automatic.

To provide an example here, if a state of muscle strength muscle mass is entered based on available tables of information based on age and height for a male if with wearing sensors from either the individual, or a group of individuals or from available big data database sources information is inputted which provides more accurate information then the baseline system and put it into the present invention will continuously be updated for better accuracy and resolution.

System Prompts

As outlined above for each step in the progression of the natural history in a stage gate fashion prompts, notices, questions, alarms, warnings, suggested actions, medications, diet changes, rehabilitative steps, psychologic or behavioral intervention will be suggested. These prompts and notices will be depicted either as graphic designated boxes or clear balloons or pop-up markers or other distinct and clear alert forms.

These notices and prompts will be interrogatable. In practical terms the user will be able to click on, tap on the notices and prompts. The notice will prompt will then yield a series of questions, actions or next steps. As also detailed here and above these notices will allow the participating individual to act upon them themselves or the system 100 will contain a means such that if action is not taken by virtue of continued input of variables of the status of the individual, i.e. details which constantly correct progression down the natural history, the system will contain an automated means to send out alarms, notifications and even actuations to lead to change.

An example of a prompt may best be seen in the case of the discharge of a patient following an episode of congestive heart failure. During that visit the patient should discuss with the physician issues related to the status of his or her symptoms, blood pressure medication use, activity level diet and the like. Similarly the physician should inquire as to a change in symptoms, weight in urination, ability to sleep flat, use of medications and adherence and compliance, activity level and return to work. Regardless of whether these are addressed by either the patient or the physician, the present system will by virtue of the intelligence of the notices and prompts have interrogate a prompts which upon tapping or actuating on the digital device computer or the like will provide suggested questions, reminders as the medications questions and discussions related to diet and activity, so that these are not missed and otherwise lost which ultimately made lead to the patient moving off the optimal natural history course. Similarly for the physician these prompts and the overall system may be integrated into the electronic health record. As such these may serve as pop-up reminders as to questions to ask actions to take as well.

Using the same example as above, during that visit the physician will inquire as to symptoms, medication use, and activity. At the same time these same issues should be and need to be in the mind of the participating individual, in this case the patient. As such if the patient does not ask or discuss each of these points, regardless, the health buddy system 100 overall will upon actuation present these notices, questions and other critical points. The system will alarm prompting the patient ask questions the physician to ask questions and as outlined above if action is not taken the system 100 will prompt action or actuate action on its own, as described via telemetry, the web or other broadcast or connectivity means.

Furthermore, the overall system 100 may function as a closed loop system. As a patient progresses down the natural history and as they run through milestones with prompts with suggested actions if they follow the appropriate action after deviating from the course or if the system 100 automatically leads to actions which helped bring them back on course the overall progression through a wellness or illness path will be continuously course corrected in a closed-loop fashion.

The following paragraphs outline the factors analyzed by the system 100 to provide a patient with health tracking and feedback.

Wellness and Illness Following a Natural History

Biological processes, particularly those involving multiple physiological systems, as in higher organisms such as man, follow a natural sequence of steps. This sequence of steps and outcomes is commonly referred to as a natural history. Natural histories apply to and occur over the spectrum of biological processes ranging from normal physiology and function to the extremes of supraphysiologic function as is associated with peak performance, athletic performance, stress and the like to the opposite extreme of aging, loss of function, decline, decay, illness, disease, and extremus, up to death.

Examples of wellness related states or processes with definable natural histories include the progression of general fitness, weight status, arterial and GI health and aging. In the case of illness, all conditions have natural histories. For the purposes of example in the present invention, we will outline coronary artery disease progression, heart failure progression and cancer.

Deconstructed Identified Steps in the Natural History of Wellness and Illness

Taking general fitness as an example, as an individual grows and matures from childhood to adolescence to young adulthood, a range of elements change in one's body. One achieves an adult status of typical muscle mass. Tendons and ligaments are defined lengths and material properties. Lungs achieve defined vital capacity muscles achieve a defined aerobic threshold and the like. At any given age from large population studies clear means exists for these and many other parameters that may be defined. As time progresses, with aging changes occur, at the mean level for the “normal” individual. If for example, as outlined in the next section one deviates from an optimal path of exogenous factors and behaviors, i.e. nutrition, diet, sleep, a wide range of outcomes may occur. If after the behavior is followed normal aging and progression will occur. If the deviation from an optimal path and behavior practice is followed either excessive weight gain or weight loss due to malnutrition and emaciation may occur, leading to frailty.

Taking weight status as an example: There are well-defined means of body mass for defined height and weight, examples being tables of body surface area and BMI. If an individual has a balanced diet, appropriate intake, is active, and free of diabetes, their weight should follow the expected natural history of progression with age until death. On the other hand if the individual has disregard for the nature of the diet the frequency of meals, snacking, does not exercise and binges they may clearly deviate from the expected natural history of the otherwise normal individual.

For the example of arterial health, the normal progression of physiology of vessels is well defined from birth to death. If an individual is active, exercises, has a balanced diet avoid smoking, and controls hypertension, the expected progression of arterial health terms of normal vascular tone, expected stiffening with age will occur. However, if the individual smokes, has uncontrolled hypertension and progressive atherosclerosis, they will evolve a different natural history with a shortened overall lifespan.

For the example of G.I. health, similar to arterial health the norms of normal aging as far as G.I. motility having a “normal constitution,” or bowel pattern will occur. However, if the individual follows a poor diet without exercise with inadequate hydration deviation will occur with progression of diverticulosis and possible irritable bowel syndrome.

In the case of illness, using coronary artery disease a natural history occurs as well. Atherosclerosis typically begins in early childhood and is largely affected by diet exercise weight and other behaviors. For the purposes of this discussion genetics which plays a large element is being removed from the equation. As such from population studies the progression of atherosclerosis in locations such as the coronaries, peripheral vessels renal vessels and carotid vessels is well-defined. What typically occurs is that with age, progressive narrowing occurs with the development of symptoms once 60 to 70% luminal obstruction develops. At that point, the individual begins to develop anginal symptoms which include chest pain, shortness of breath, fatigue, lack of exercise capacity, lightheadedness and even syncope. If the individual recognizes these symptoms and engages with the health care system i.e. their internist and cardiologist, and follows a therapeutic plan, the natural history may be modified. For instance the progression of atherosclerosis left unchecked may ultimately lead to a progression from chronic stable angina to unstable angina with possible eventual myocardial infarction. On the other hand, early intervention will change the course leading to prevention of progression to infarction and with aggressive therapy a degree of regression.

For the case of congestive heart failure, this syndromic malady follows a defined natural history of progression. Patients move through what has been defined by the New York heart Association from class I ultimately to class IV heart failure. Class one is defined as minimal symptomatology and shortness of breath only with severe exertion. Class II is defined as symptomatology with moderate exertion. Class III is defined as symptomatology with mild exertion. Class IV his symptomatology and rest. As such, the natural history in terms of survival for these classes is well-defined. With class for heart failure, patients typically have a 75% mortality within one year. As such the ability to move patients off of the defined trajectory for a given class is the desired goal to ultimately improve survival. As such defining the stage and status of the patient, identifying variables that modify their progression and actively engaging with the patient to adhere to these steps is critical in their survival.

For the example of colon cancer, this, like many cancers, evolves with what is termed as stage and grade of the tumor. As such, being able to identify early involvement with superficial malignancy as opposed to transmural progression of the disease through the wall with eventual metastasis locally and at a distance is the desired goal. These individual steps are well-defined and intervening to prevent progression and reduce morbidity and mortality is the desired goal.

Elements that Modify Wellness and Illness Progression

Specifically, for general fitness an individual that engages in regular stretching, strength and aerobic exercise and diet monitoring and control is much less likely to have reduced exercise capacity, reduced vital capacity and obesity than one with disregard or frank purposeful avoidance and negligence as to these actions and parameters. For weight status, an individual that is cognizant of intake in relation to activity is much less likely to become heavier with age compared to one that is not watchful or has frank disregard for diet issues. For arterial health, the individual that partakes in regular aerobic exercise, avoids excess fats and sugar in the diet and has control of blood pressure, freedom from diabetes, and takes arginine and natural anti-inflammatory compounds is more likely to maintain good arterial and endothelial health than those with disregard for or frank exercise avoidance, poor blood pressure control, diabetes with poor control and unhealthy atherogenic and obesity prone diet habits.

For GI health individual that it's a balanced diet, adequate roughage, avoids processed foods is more likely to have a good outcome than those who eat very narrow types of foods, high fats and processed foods with preservatives and nitrites. For an aging individual that takes care of his health, exercises, obtains the appropriate amount of sleep, avoids smoking and alcohol, and recreational drugs is more likely to have a better natural history and a longer life than those under high stress with smoking alcohol, and sedentary lifestyles. It should be understood that clearly genetics dictate a large element of natural history however the point as it relates to this invention is that a. Complex life processes follow a pathway of evolution i.e. a natural history which may be delineated as to critical steps and b. Behavioral issues as outlined above independently have an effect on the outcome besides intrinsic elements dictated by genetics, which are unmodifiable.

Stewardship and Outcome of Natural History Relate to Understanding and Engagement

As one can begin to discern from the above discussion, there are many modifiable elements and variables that an individual or an individual's caretaker can manipulate to alter the natural history progression of wellness or illness. As such, to begin this process the individual, or the caretaker, must first recognize and understand the overall wellness or illness process, and the nature of these component steps or conditions that can modify this process, their importance and how and when to actually implement these steps to affect a change. This requires a basic level of understanding, a level of education, appreciation of elements of science and the biology of health and illness. Unfortunately, there is a great variability amongst the population at large as to their education, background, and appreciation of these factors.

In addition to educational elements of the individual which impact on this understanding and engagement, there are psychological and behavioral and attitudinal elements which have a large impact as well. If one looks at a large population of patients what emerges is that there is a spectrum of engagement from those that are fully engaged, even over engaged, to the other end of those with total disregard and even an aversion to involvement.

An additional element that impacts the effectiveness of natural history progression relates to the efficacy of inter-personal interactions with those involved with either “wellness” delivery or healthcare delivery. For example, concerning wellness, if an individual is working with a trainer or a coach and they don't psychologically mash or have communication issues, the impact of the guidance delivered may often go unrealized. This is even more the case in healthcare delivery. If a patient interacts with the physician and the physician is both short on time and on true interaction with the patient to make sure they “get it,” the efficacy of the interaction will be largely if not completely undermined. From surveys it is clear that poor communication, on both ends i.e. patient to Dr. and Dr. the patient is a problem in healthcare interactions. Research shows that 80% of patient complaints relate to poor communication. Similarly, and the information provided more than 60% of patients have a poor understanding of their health data and are unaware of all aspects of their treatment-medications, activity and rehabilitation that they have been prescribed to achieve an optimal outcome.

Spectrum of Understanding and Engagement for the Population

As such to practically categorize patients as to where they fit in the spectrum of both educational understanding and psychological engagement one can matrix these into groups. Examples of these groups include: 1. those with high educational background and understanding coupled with highly motivated to participate and engage in the program. 2. Those with basic educational understanding that are engaged with the program and on board with therapy. 3. Those with minimal understanding who do not get an otherwise our non-comprehending of the gravity or severity of the condition where the necessity to adhere to a therapeutic plan and finally 4. Those with either limited understanding or understanding with frank disregard or purposeful desire not to participate or disregard a designated therapeutic plan. As such, it is understood that these radiations and delineations may be further subdivided and that levels of understanding versus levels of psychological engagement may be mixed and matched to create additional subsets of patients.

Collective Experience, Clinical Studies, and Big Data Allow Definition of Natural History, Best Practices, and Corrective Actions

In the discussion and examples provided above as to definition of natural history for both wellness and illness, it should be understood that details of these processes for any specific condition or state which the present invention will track monitor and intervene are typically well defined in the literature or in health, physiology or medical textbooks. However, in today's world, many of these “established,” natural histories may in fact be corrected or improved based on the dramatically increased availability of real-world data across populations based on the increasing rollout of large clinical trials and studies and the connectivity of the world as far as sharing of collective experience. Further, with the emergence of “big data,” which refers to the volume, variety, velocity and veracity of data available, otherwise non-discernible concepts, outcomes and processes are becoming apparent through the processing of structured and unstructured data to yield nonobvious outcomes. As such, these additional insights may be utilized to further refine natural history progression and component steps. In the present invention these elements-collective experience, clinical studies and big data will be employed to continuously improve the definition of natural history elements and corrective steps and actions to modulate these processes.

The Connected World and Related Technologies Allow Instant Access to Information

We are living in a rapidly transforming world. Over the past 10 to 20 years we have seen the emergence of the digital society, the growth and arborization of the web, the reliance on Google and search engines as our means of research, the explosion of social media and connectivity and the emergence of the cell phone as the ultimate digital device. As such, as it relates to the present invention, information from the web in terms of group think, group innovation and open innovation will be incorporated as means of both further defining natural history elements of wellness and disease processes as well as the interventional aspect of the present invention where defined steps, milestones, critical path stage and Gates will continuously be inputted to allow updating of the system so as to refine its efficacy.

In addition to the web and connectivity enhancing and continuously course correcting and improving the two vital elements of the present invention so far described, i.e. 1. the definition, delineation and deconstruction of vital elements in the natural history of wellness and illness processes as well as 2. the identification and definition of critical interventional steps to otherwise modulate or alter the course of progression of the natural history to which they are related, the web and connectivity will be utilized in the present invention to provide individual, patient specific information as to the progression of that individual to personalize this system as well. For example, if a an individual is attempting to maintain and optimize wellness and fitness the inputting of their own weight data, diet and intake data, strength data, exercise and activity data will further refine this system on a personalized precision basis. As described herein, much of this information may be input via a variety of means including conventional inputting of analog data, access from digital sources and up loading or other input via a variety of wearable or implantable sensors I tell Bobby down a few minutes. Similarly, for disease, the inputting of laboratory imaging and other health specific information will further refine the status and specific point in natural history of the individual and therefore further define the specific interventional elements that need to be brought up, registered and applied to affect or alter the course of progression of the patient.

Sensors—Stationary and Wearable for Instant Data Input

To personalize and enhance the accuracy and specificity of the present invention for a given individual the range of present and emerging sensors 150 may be utilized. There is explosive growth in the development of novel sensors measuring health-related parameters. These include sensors for motion—with six degrees of freedom as to direction, acceleration, angulation and rotation; cardiovascular parameters—e.g. heart rate, blood pressure, ECG, rhythms; pH; O2, CO2 and other gases; electrolytes; hemoglobin; material properties—i.e. stiffness; hydration; sweat and the like. These sensors will be configured to integrate with the present invention system and provide information as the actual, individual, personalized progression of the sensor-subjected individual. As such this specific input data will then fine tune and enhance the accuracy of both the stage of progression and the specific variables of progression of an individual. This input will also guide the details, nature and content of specific interventional steps, milestones, guideposts and alarms that will emerge.

Data Storage, Telemetry, and Connectivity—Use for Individual-Independent Corrective Actions

Increasingly medical systems and devices today are being developed with data storage, telemetry and connectivity capabilities. These capabilities serve as means of monitoring and documenting events, capturing change, reacting to and instantly delivering data to appropriate locations, entities and individuals. Examples of these include a pacemaker device sending data of imminent battery run-down, or uploading data to a server on captured arrhythmias. Emerging are systems that lead to feedback and change, i.e. as closed loop arrangements. As such in the present system it will be specifically configured to, by virtues of running the natural history “algorithm” for a given wellness or illness path, coupled with the emergence and pop-up of signpost interventional events, describe a means to send out alarms or actually dynamically, or automatically, affect a change or corrective action.

1. A non-transitory computer-readable medium that stores a program for analyzing health, that when executed, causes a processor to:
receive input of a plurality of health variables associated with an individual or subject;
process the plurality of health variables to calculate composite wellness, performance, and disease/decay variables; and
convert the wellness, performance, and disease/decay variables into graphical representations, wherein said graphical representations are displayed against a time axis; wherein said graphical representations update in real-time based on the input of additional health variable data.

2. The non-transitory computer-readable medium of claim 1, wherein the program further causes a processor to output one or more cues, notices and/or alarms in response to interventional steps, milestones, guideposts.

3. The non-transitory computer-readable medium of claim 1, wherein the individual or subject is an animal including man.

4. The non-transitory computer-readable medium of claim 1, wherein the program further causes a processor to output one or more notices or recommendations to improve the composite wellness, performance, and disease/decay variables.

5. The non-transitory computer-readable medium of claim 4, wherein the notices or recommendations may be advice, actions, questions, prescriptions, care plans, or rehab plans.

6. The non-transitory computer-readable medium of claim 4, wherein the program causes a processor to tailor notices and recommendations to adjust to the patient's level of understanding.

7. The non-transitory computer-readable medium of claim 1, wherein the input of a plurality of health variables is received from one or more sensors or from a manual input of data by the individual or subject.

8. The non-transitory computer-readable medium of claim 1, wherein the program causes a processor to produce a graphical representation of an avatar to advise the subject.

9. A system for assisting subjects in health tracking comprised of a graphical user interface, a peripheral device or a computer, one or more sensors, and one or more remote servers, wherein the system receives input of a plurality of health variables associated with a subject, processes the plurality of health variables to calculate composite wellness, performance, and disease/decay variables, and converts the wellness, performance, and disease/decay variables into graphical representations, wherein said graphical representations are displayed against a time axis; and wherein said graphical representations update in real-time based on the input of additional health variable data.

10. The system of claim 9, wherein the system further outputs one or more notices or recommendations in response to interventional steps, milestones, guideposts.

11. The system of claim 10, wherein the notices or recommendations may be advice, actions, questions, prescriptions, care plans, or rehab plans.

12. The system of claim 10, wherein the notices or recommendations will vary based on the subject's profile and/or level of understanding.

13. The system of claim 9, wherein the system outputs one or more recommendations to improve the composite wellness, performance, and disease/decay variables.

14. The system of claim 9, wherein the system receives the input of a plurality of health variables from one or more sensors or from a manual input of data by the patient through the graphical user interface.

15. The system of claim 9, wherein the system outputs a graphical representation of an avatar to advise the subject.
